(19) United States
(12) Patent Application Publication
(10) Pub. No.: US 2003/0031206 A1
(43) Pub. Date: Feb. 13, 2003

(54) Bandwidth management for packetized image data

(76) Inventor: Tim Goldstein, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/928,317

(22) Filed: Aug. 13, 2001

(51) Int. Cl. H04J 3/24

(52) U.S. Cl. 370/474; 370/392; 370/389

(57) ABSTRACT

A method, device, and computer readable medium for communicating a plurality of data sets between a source and a destination. The technology involves segmenting each data set into a plurality of segments and assigning a transmission precedence to each of the segments according to the data set from which it came. The segments are then transmitted in order of the assigned precedence whereby lower precedence segments are transmitted during idle transmission time between higher precedence segments.

### TECHNICAL FIELD

This disclosure generally relates to multiplex communications, and, more particularly, to a prioritized queuing arrangement for packetized image data.

### BACKGROUND

Point-to-point networks must generally have sufficient capacity to handle all communications “traffic” during their busiest time period. For conventional “circuit-switched” telephone networks, there is usually a “busy hour” during each weekday morning when communications traffic is at its highest level. However, once the weekday is over, the utilization rate drops precipitously to a low of about 0.2% of capacity around 2 a.m. Consequently, many telephone circuits must be designed with excess capacity that may never be fully utilized.

Store-and-forward communication systems, such as Telex, generally have more even utilization rates throughout the day. However, such “message-switched” networks require that each message be sent in its entirety before other messages are queued for transmission. Consequently, certain messages are always going to be delayed, especially when earlier messages in the queue are quite large. Furthermore, there is always a concern that the queued message may overflow the storage facility during times of peak utilization rates.

Packet networks attempt to balance the immediacy and underutilization of point-to-point networks against the slower speed and higher utilization rates of store-and-forward networks. In a packet network, each message, or “data set,” is transmitted in several “segments” (referred to as packets, frames, or blocks) through a process of “segmentation” at one end of the communication circuit and “reassembly” at the other end of the circuit. Each segment of data is typically “encapsulated” with address and control information so that segments from various sources can be carried on the same circuits. Each segment also receives a “sequence number” in order to facilitate reassembly at the destination.

Various communications standards, or “protocols” have developed for packet-switched networks. For example, many Wide Area Network (“WAN”) protocols are based upon the Open System Interconnection (“OSI”) reference model and groups of specifications such as Integrated Sources Digital Network (“ISDN”), Asynchronous Transfer Mode (“ATM”), Fiber Distribution Interface (“FDDI”), Synchronous Optical Network (“SONET”), and Very Small Aperture Terminal (“VSAT”) protocols. Other protocols have been implemented for Local Area Networks (“LANs”), including Carrier Sense Multiple Access (“CSMA”), Ethernet, and various token ring configuration standards. Each of these standards is incorporated by reference here.

These smaller networks are often connected together into larger networks accessible only by the smaller networks' members with authorization or “intranets.” The “Internet” is the largest of the interconnected packet-switched networks and includes thousands of networks that are connected together by gateways and routers that forward segments between various “host” computers according to the Transmission Control Protocol over Internet Protocol (“TCP/IP”) suite set forth in Standards 5, 7, and other Request for Comments (“RFCs”) of the iternet Engineering Task Force (“IETF”), which are hereby incorporated by reference into this disclosure. IP provides guidelines for the “fragmentation” (segmentation), addressing, and routing of “datagram” packet segments while TCP adds reliability, multiplexing, and flow-control parameters.

The IP datagram format includes a quality of service (“QoS”) parameter. In particular, a “type of service” field is provided in each datagram with a service “precedence” indicator for treating high-precedence traffic as being more important than other traffic. This protocol suggests that this can be implemented by accepting only traffic above a certain precedence during times of high load. Type of service is discussed in more detail in RFCs 1122 and 1349, also incorporated by reference here.

“Flow control” refers to the management of the data flow from source to destination so as to maintain full capacity of all components in the communications system. Flow control may be achieved with hardware, software, or a combination thereof. Typically, the receiver at the destination will have a fixed-size memory buffer into which data is written as soon as it is received. When the amount of buffered data exceeds a certain level near the capacity of the buffer, the receiver will signal the transmitter at the source to stop transmitting until a certain amount of data has been read from the buffer, and the buffer capacity has been restored. At that point, the receiver will typically signal the transmitter to resume transmission to start filling the buffer once again.

For example, the flow control mechanism in the TCP is based upon a “window” which defines a contiguous interval of sequence-numbered datagrams that a receiver can accept without overrunning it buffers. As data is accepted by the receiver, acknowledgment is sent back to the transmitter in the form of the highest sequence number that the receiver can receive without causing problems. When the buffer remains full, the receiver may simply send multiple acknowledgments with the same window. In that case, a “timeout” or last connection may occur resulting in idle time between the transmitter and receiver. This type of idle time is a significant source of data transmission delays, especially when all of the high-priority segments in a queue must be sent before any lower-priority segments.

For example, U.S. Pat. No. 6,018,515 is incorporated by reference into this disclosure and describes a message buffering system for prioritized message transmission and congestion management that is configurable for different communications applications. A plurality of buffers are provided at a communications point with different buffers corresponding to different message priorities. The buffers may be, for example, first-in-first-out (FIFO) buffers. Messages to be transmitted from the communications point are processed to determine the priority of each message. Each message is stored in one of the plurality of buffers corresponding to its determined priority. Messages are then transmitted starting from the highest priority buffer, continuing to the next priority buffer, and so forth.

U.S. Pat. No. 6,205,150 is also incorporated by reference here and discloses a method for scheduling lower priority and higher priority data segments in a network system. The method allows a network device to schedule the order in which data segments are sent and received on a network system using multiple queues. As the network device receives data segments, the network device places data segments into a first queue and sorts the data segments as higher priority and lower priority data segments based upon a transmission deadline of each data packet. Subsequently, the network device places the high priority data segments into a second queue and the lower priority data segments into a third queue. The network device schedules data segments for execution in the second queue using a first scheduling method while using a second scheduling method to schedule data segments in the third queue. When a transmission deadline for a lower priority data packet expires in the third queue, the network device promotes a data packet from the third queue to the second queue for rescheduling.

Even with prioritized buffers, however, there can still be delays during idle time between segments from the highest priority buffer being used at any particular moment.

### SUMMARY OF THE INVENTION

These and other shortcomings of conventional technology are addressed here by providing a method, device, and computer readable medium for communicating a plurality of data sets between a source and a destination. The technology involves segmenting each data set into a plurality of segments and assigning a transmission precedence to each of the segments according to the data set from which it came. The segments are then transmitted in order of the assigned precedence whereby lower precedence segments are transmitted during idle transmission time between higher precedence segments.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view of an embodiment of a camera according to the present invention.

FIG. 2 is a schematic view of an embodiment of a data transfer system including the camera such as that shown in FIG. 1.

FIG. 3 is an exemplary flow chart for the data transfer system of FIG. 2.

FIG. 4 is an exemplary timing diagram for the data transfer system of FIG. 2.

### DETAILED DESCRIPTION OF THE PREFERRED EMBODIMENTS

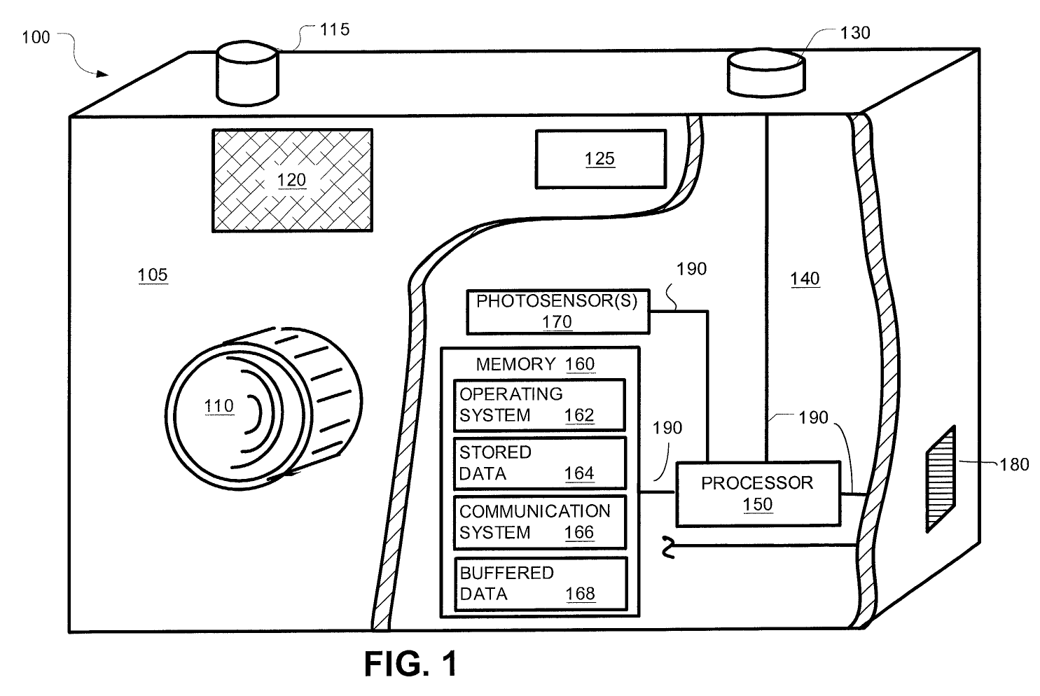

FIG. 1 is a schematic diagram of an embodiment of a camera 100 according to the present invention. Although FIG. 1 is illustrated as a digital camera for taking still photographs, a variety of other cameras may be similarly configured, including film cameras, video cameras, motion picture cameras, and other devices that capture and/or record image information. Other types of data capturing devices besides image data capturing devices may also be used, including sound recorders for capturing audio data; energy recorders for capturing energy data such as temperature, pressure, flow, voltage, and/or current; and personal digital assistants for capturing personal data (contacts, appointments, etc.).

The camera 100 includes a body 105 that supports a lens 110, shutter activator 115, flash 120, view finder 125, and control knob 130. The camera 100 may also be provided with a variety of other components, such as a light sensor, range finder, focal length control, microphone, and/or other features.

Shown within the body 105 is a block diagram of certain components for implementing a management system 140 for managing various operational aspects of the camera 100 as described in more detail below. The camera management system 140 may be implemented in a wide variety of electrical, electronic, computer, mechanical, and/or manual configurations. However, in a preferred embodiment, the management system 140 is at least partially computerized with various aspects of the system being implemented by software, firmware, hardware, or a combination thereof.

In terms of hardware architecture, the management system 140 preferably includes a processor 150 and memory 160 that are connected to one or more input and/or output (“I/O”) devices, such as photosensor 170, data port 180, switch 130, flash 120, and/or shutter control 115. Each of the I/O devices is communicatively coupled via a local interface 190 to the processor 150. However, for the sake of simplicity, the interface 190 for the flash 120 and shutter control 1 15 are not shown in FIG. 1.

The local interface 190 may include one or more buses, or other wired connections, as is known in the art. Although not shown in FIG. 1, the interface 190 may have other communication elements, such as controllers, buffers (caches) driver, repeaters, and/or receivers. Various address, control, and/or data connections may also be provided with the local interface 190 for enabling communications among the various components of the camera management system 140. The data port 180 is an external interface for communicating with the local interface 190. For example, the port 180 may be a receptacle for receiving an (electrical or optical) cable or an electromagnetic sensor for wireless communications.

The memory 160 may have volatile memory elements (e.g., random access memory, or “RAM,” such as DRAM, SRAM, etc.), nonvolatile memory elements (e.g., hard drive, tape, read only memory, or “ROM,” CDROM, etc.), or any combination thereof. The memory 160 may also incorporate electronic, magnetic, optical, and/or other types of storage devices. A distributed memory architecture, where various memory components are situated remote from one another, may also be used.

The processor 150 is preferably a hardware device for implementing software that is stored in the memory 160. The processor 150 can be any custom-made or commercially available processor, including semiconductor-based microprocessors (in the form of a microchip) and/or macroprocessors. The processor 150 may be a central processing unit (“CPU”) or an auxiliary processor among several processors associated with the camera 100. Examples of suitable commercially-available microprocessors include, but are not limited to, the McKinley processor and PA-RISC series of microprocessors from Hewlett-Packard Company, U.S.A., the 80×86 and Pentium series of microprocessors from Intel Corporation, U.S.A., PowerPC microprocessors from IBM, U.S.A., Sparc microprocessors from Sun Microsystems, Inc, and the 68××× series of microprocessors from Motorola Corporation, U.S.A.

The memory 160 stores software in the form of instructions and/or data for use by the processor 150. The instructions generally include one or more separate programs, each of which comprises an ordered listing of executable instructions for implementing one or more logical functions. The data generally include one or more stored data sets corresponding to separate images that have been captured by camera 100. Other data may also be included, such as an owner or serial number identifier, credit card data, and/or user settings data. In the particular example shown in FIG. 1, the software contained in the memory 160 includes a suitable operating system (“O/S”) 162, along with stored data 164, a communication system 166, and any buffered data 168 as described in more detail below.

The operating system 162 implements the execution of other computer programs, such as the communication 166, and provides scheduling, input-output control, file and data management, memory management, communication control, and other related services. Various commercially-available operating systems 160 may be used, including, but not limited to, the DigitaOS operating system from Flashpoint Technologies, U.S.A., the Windows operating system from Microsoft Corporation, U.S.A., the Netware operating system from Novell, Inc., U.S.A., and various UNIX operating systems available from vendors such as Hewlett-Packard Company, U.S.A., Sun Microsystems, Inc., U.S.A., and AT&T Corporation, U.S.A.

In the architecture shown in FIG. 1, the communication system 166 may be a source program (or “source code”), executable program (“object code”), script, or any other entity comprising a set of instructions to be performed as described in more detail below. In order to work with a particular operating system 162, any such source code will typically be translated into object code via a conventional compiler, assembler, interpreter, or the like, which may (or may not) be included within the memory 160. The communication system 166 may be written using an object oriented programming language having classes of data and methods, and/or a procedure programming language, having routines, subroutines, and/or functions. For example, suitable programming languages include, but are not limited to, C, C++, Pascal, Basic, Fortran, Cobol, Perl, Java, and Ada.

When the communication 166 and/or operation system 162 are implemented in software, they can be stored on any computer readable medium for use by, or in connection with, any computer-related system or method, such as the management system 140 on camera 100 or an emulator for that system. In the context of this document, a “computer readable medium” includes any electronic, magnetic, optical, or other physical device or means that can contain or store a computer program for use by, or in connection with, a computer-related system or method. The computer-related system may be any instruction execution system, apparatus, or device, such as a computer-based system, processor-containing system, or other system that can fetch the instructions from the instruction execution system, apparatus, or device and then execute those instructions. Therefore, in the context of this document, a computer-readable medium can be any means that will store, communicate, propagate, or transport the program for use by, or in connection with, the instruction execution system, apparatus, or device.

For example, the computer readable medium may take a variety of forms including, but is not limited to, an electronic, magnetic, optical, electromagnetic, infrared, or semiconductor system, apparatus, device, or propagation medium. More specific examples of a computer-readable medium include without limitation an electrical connection (electronic) having one or more wires, a portable computer diskette (magnetic), a random access memory (“RAM”) (electronic), a read-only memory (“ROM”) (electronic), an erasable programmable read-only memory (“EPROM,” “E.EPROM,” or Flash memory) (electronic), an optical fiber (optical), and a portable compact disc read-only memory (“CDROM”) (optical). The computer readable medium could even be paper or another suitable medium upon which the program is printed, as the program can be electronically captured, for instance via optical sensing or scanning of the paper, and then compiled, interpreted or otherwise processed in a suitable manner before being stored in the memory 160.

In another embodiment, where either or both of the operating system 162 and communication system 168 are at least partially implemented in hardware, the camera management system 140 may be implemented using a variety of technologies including, but not limited to, discrete logic circuit(s) having logic gates for implementing logic functions upon data signals, application specific integrated circuit(s) (“ASIC”) having appropriate combinational logic gates, programmable gate array(s) (“PGA”), and/or field programmable gate array(s) (“FPGA”).

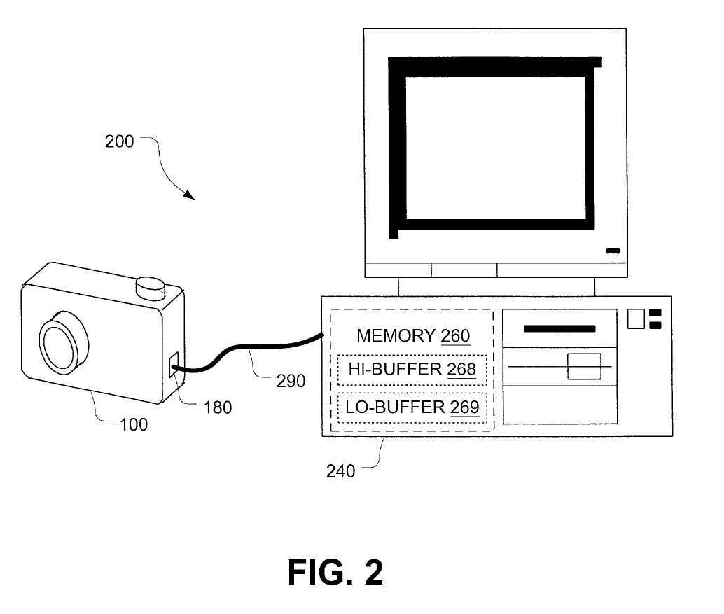

Once the management system 140 is accessed, the processor 150 executes instructions in the operating system 162 that are stored within the memory 160. The processor 150 receives and executes further instructions in connection with the stored data 164, buffered data 168, and any I/O devices so as to generally operate the system 140 pursuant to the instructions and data contained in the software and/or hardware as described below with regard to FIGS. 2-4.

FIG. 2 is a schematic view of an embodiment of a data transfer system 200 between a camera and a computing means such as that shown in FIG. 1, namely, camera 100 (source) and a computer 240 (destination). The data port 180 (transmitter) of the camera 100 is connected to a data conduit 290 that leads to the computer 240. Although the data conduit 290 is illustrated in FIG. 2 as a cable, a variety of other wired, wireless, and/or other communications technologies may be used to transfer data from the camera 100 to the computer 240. The data computer 240 preferably includes a memory 260 (receiver) with multiple buffers for receiving data having different priorities. For example, the computer 240 may be a retail kiosk for allowing camera users to print and/or send prioritized sets of stored data 164 from the memory 160 in the camera 100 to a high priority, hi-buffer 268 and a lower priority, lo-buffer 269. Additional priorities and/or buffers may also be provided and/or a single buffer may be used with data having different priorities.

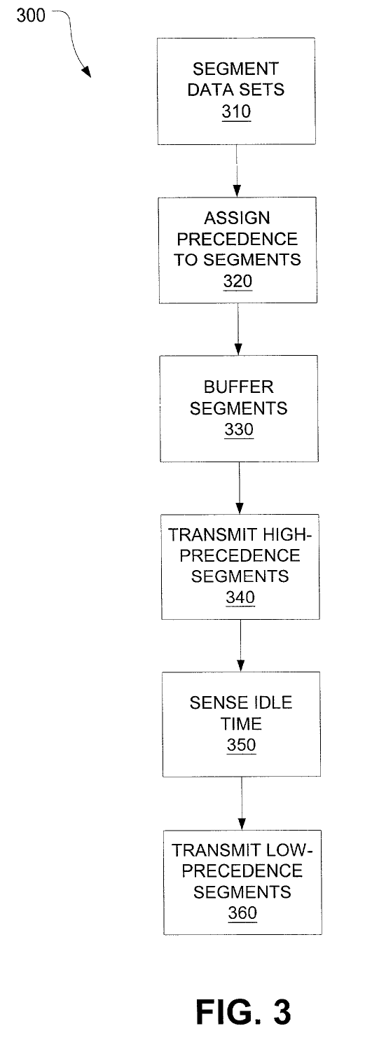

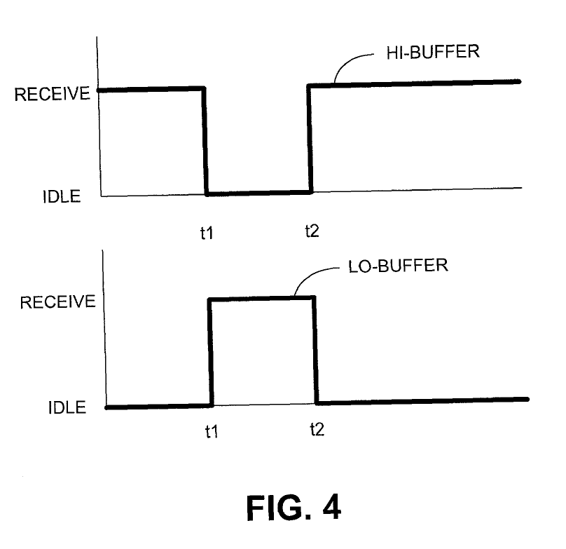

FIG. 3 is a flow diagram for one embodiment of communication system 166. FIG. 4 illustrates an exemplary timing diagram that preferably corresponds to the flow diagram in FIG. 3. More specifically, FIG. 3 shows the architecture, functionality, and operation of an embodiment of a software system 300 according to the present invention for implementing the communication system 166 with the management system 140. However, as noted above, a variety of other computer, electrical, electronic, mechanical, and/or manual systems may be similarly configured.

Each block in FIG. 3 represents an activity, step, module, segment, or portion of computer code that will typically comprise one or more executable instructions for implementing the specific logical function(s). It should also be noted that, in various alternative implementations, the functions noted in the blocks will occur out of the order noted in FIG. 3. For example, multiple functions in different blocks may be executed substantially concurrently, in a different order, incompletely, and/or over an extended period of time, depending on the functionality involved. Various steps may also be completed manually.

In the flow diagram 300 shown in FIG. 3, the stored image data 164 is first segmented into a plurality of data sets at step 310. For example, each captured image in the camera 100 may be divided into packets, frames, and/or blocks using various communications protocols, such as the IP protocol for segmenting data sets into datagrams. At step 320, a transmission precedence is assigned to some or all of the segments. For example, a high transmission precedence may be assigned to a segment from a particular image which is being transferred to a kiosk, or other computer 240, for reproduction and/or storage. The segments for the remaining image data sets may be assumed to have a lower precedence or actually assigned a lower precedence.

The transmission precedence is preferably assigned according to the image data set from which it was segmented. For example, all of the segments from the highest priority image data set which are intended to be processed by the computer 240 may be given the highest precedence. Segments from all other data sets are then given a lower precedence. Alternatively, the segments of more than one data set may be given a high precedence and/or more than one precedence level may be assigned to different segments of the same data set.

At step 330, some or all of the segments with an assigned precedence are placed in a memory buffer in the camera 100. The memory buffer may be a portion of the memory 160, as shown in FIG. 1, or may be separate from the memory 160. Segments having different levels of precedence are preferably stored in different sections of memory 160, or different memory buffers, in order to provide faster access to the buffered data 168. However, segments with a different transmission precedence may also be loaded into the same buffer memory.

At step 340, the buffered data 168 is transmitted from the camera 100 through the data port 180 over the data conduit 290, where it is received by the memory 260 in computer 240, as shown in FIG. 2. The segments are preferably transmitted in order of the assigned precedence so that the higher precedence segments are transmitted before the lower precedence segments. In addition, the lower precedence segments are transmitted during idle transmission time between high precedence segments. For example, this idle time might be caused by rendering of the transmitted data or other operational aspects of the computer 240.

For example, and not by way of limitation, referring to FIG. 2, the high precedence segments are preferably transmitted to the hi-buffer 268, while the low precedence segments are preferably transmitted to the lo-buffer 269. By providing separate buffers in the memory 260, low priority segments can be transmitted by the data port 180 and received by the memory 260 when the hi-buffer 268 is idle and therefore unable to receive additional high-precedence image data segments.

In order to prevent a time-out while the low precedence packets are waiting, a low precedence packet may be sent out of sequence. For example, the system may be configured to send a low precedence packet after a certain number of high precedence packets or after a certain period of idle time. Various ratios of high precedence packets to low precedence packets may also be used. For example and not by way of limitation, for every one hundred high precedence packets transmitted, three low precedence packets may be sent (assuming sufficient packets are in the camera 100).

FIG. 4 illustrates an example timing sequence for the hi-buffer 268 (top) and low-buffer 269 (bottom). During the time between t1 and t2, the hi-buffer 268 is idle and therefore unable to receive additional high-precedence data segments. For example, during time t1-t2, the hi-buffer 268 may be filled to capacity. As shown in the lower portion of FIG. 4, during the time that the hi-buffer 268 is idle, the lo-buffer 269 will be receiving low-precedence data segments. By transmitting low-precedence segments during idle transmission time between high-precedence segments, additional data sets can be transmitted between the camera 100 and the computer 240 than would otherwise be expected. These additional data sets could then be presented to the operator of the camera 100 for additional processing and/or storage without compromising the speed of the data transfer system 200.

1. A method for communicating a plurality of data sets, comprising:
segmenting each data set into a plurality of segments;
assigning a transmission precedence to each of the segments according to the data set from which it was segmented; and
transmitting the segments in order of the assigned precedence whereby lower-precedence segments are transmitted during idle transmission time between higher-precedence segments.

2. The method recited in claim 1 further comprising assigning a priority to at least one of the data sets whereby segments from each such data set are assigned a higher precedence.

3. The method recited in claim 1 wherein the segments are Internet Protocol datagrams.

4. The method recited in claim 1 wherein the data sets are image data sets.

5. A device for communicating a plurality of data sets, comprising:
means for segmenting each data set into a plurality of segments;
means for assigning a transmission precedence to each of the segments according to the data set from which it was segmented; and
means for transmitting the segments in order of the assigned precedence whereby lower-precedence segments are transmitted during idle transmission-time between higher-precedence segments.

6. The device recited in claim 5 further comprising means for assigning a priority to at least one of the data sets whereby segments from a priority data set are assigned a higher precedence.

7. The device recited in claim 5 wherein the segments are Internet Protocol datagrams.

8. The device recited in claim 5 wherein the data sets are image data sets.

9. A computer readable medium for communicating a plurality of data sets, comprising:
logic configured to segment each data set into a plurality of segments;
logic configured to assign a transmission precedence to each of the segments according to the data set from which it was segmented; and
logic configured to transmit the segments in order of the assigned precedence whereby lower-precedence segments are transmitted during idle transmission time between higher-precedence segments.

10. The computer readable medium recited in claim 9 further comprising logic that assigns a priority to at least one of the data sets whereby segments from a priority data set are assigned a higher precedence.

11. The computer readable medium recited in claim 9 wherein the segments are Internet Protocol datagrams.

12. The method recited in claim 9 wherein the data sets are image data sets.
